(19) United States
(12) Patent Application Publication
(10) Pub. No.: US 2007/0134635 A1
(43) Pub. Date: Jun. 14, 2007

(54) COGNITIVE TRAINING USING FORMANT FREQUENCY SWEEPS

(75) Inventors: Joseph L. Hardy, Richmond, CA (US); Henry W. Mahncke, San Francisco, CA (US); Travis W. Wade, San Francisco, CA (US)

Correspondence Address: HUFFMAN LAW GROUP, P.C., 1900 MESA AVE., COLORADO SPRINGS, CO, 80906, US

(73) Assignee: Posit Science Corporation, San Francisco, CA (US)

(21) Appl. No.: 11/610,432

(22) Filed: Dec. 13, 2006

Related U.S. Application Data
(60) Provisional application No. 60/749,997, filed on Dec. 13, 2005.

(51) Int. Cl. G09B 19/00

(52) U.S. Cl. 434/236

(57) ABSTRACT

A method on a computing device for enhancing the memory and cognitive ability of a participant by requiring the participant to differentiate between rapidly presented aural stimuli. The method trains the time order judgment of the participant by iteratively presenting sequences of upward and downward formant frequency sweeps, in random order, separated by an inter-stimulus interval (ISI). The upward and downward formant frequency sweeps utilize frequencies common in formants, i.e., the characteristic frequency components common in human speech. Icons are associated with the upward and downward formant frequency sweeps to allow the participant to indicate an order in which the sweeps are presented (i.e., UP-UP, UP-DOWN, DOWN-UP, and DOWN-DOWN). Correct/incorrect selection of an order causes the ISI and/or the duration of the frequency sweeps to be adaptively shortened/lengthened. A maximum likelihood procedure may be used to dynamically modify the stimulus presentation, and/or, to assess the participant's performance in the exercise.

### CROSS REFERENCE TO RELATED APPLICATION(S)

This application claims the benefit of the following U.S. Provisional Patent Application, which is incorporated herein in its entirety for all purposes:

| | | | |
|---|---|---|---|
| PS.0118 | 60/749997 | Dec. 13, 2005 | HIFI EXPANSION PACK |

The following references are hereby incorporated by reference in their entirety as though fully and completely set forth herein:

U.S. patent application Ser. No. 11/032,894, titled “A METHOD FOR ENHANCING MEMORY AND COGNITION IN AGING ADULTS”, filed Jan. 11, 2005, and whose inventors are Michael M. Merzenich, Daniel M. Goldman, Joseph L. Hardy, Henry W. Mahncke, and Jeffrey S. Zimman.

### FIELD OF THE INVENTION

This invention relates in general to the use of brain health programs utilizing brain plasticity to enhance human performance and correct neurological disorders, and more specifically, to a method for improving cognition and memory in a participant using formant frequency sweeps.

### BACKGROUND OF THE INVENTION

Almost every individual has a measurable deterioration of cognitive abilities as he or she ages. The experience of this decline may begin with occasional lapses in memory in one's thirties, such as increasing difficulty in remembering names and faces, and often progresses to more frequent lapses as one ages in which there is passing difficulty recalling the names of objects, or remembering a sequence of instructions to follow directions from one place to another. Typically, such decline accelerates in one's fifties and over subsequent decades, such that these lapses become noticeably more frequent. This is commonly dismissed as simply “a senior moment” or “getting older.” In reality, this decline is to be expected and is predictable. It is often clinically referred to as “age-related cognitive decline,” or “age-associated memory impairment.” While often viewed (especially against more serious illnesses) as benign, such predictable age-related cognitive decline can severely alter quality of life by making daily tasks (e.g., driving a car, remembering the names of old friends) difficult.

In many older participants, age-related cognitive decline leads to a more severe condition now known as Mild Cognitive Impairment (MCI), in which sufferers show specific sharp declines in cognitive function relative to their historical lifetime abilities while not meeting the formal clinical criteria for dementia. MCI is now recognized to be a likely prodromal condition to Alzheimer's Disease (AD) which represents the final collapse of cognitive abilities in an older participant. The development of novel therapies to prevent the onset of this devastating neurological disorder is a key goal for modern medical science.

The majority of the experimental efforts directed toward developing new strategies for ameliorating the cognitive and memory impacts of aging have focused on blocking and possibly reversing the pathological processes associated with the physical deterioration of the brain. However, the positive benefits provided by available therapeutic approaches (most notably, the cholinesterase inhibitors) have been modest to date in AD, and are not approved for earlier stages of memory and cognitive loss such as age-related cognitive decline and MCI.

Cognitive training is another potentially potent therapeutic approach to the problems of age-related cognitive decline, MCI, and AD. This approach typically employs computer- or clinician-guided training to teach subjects cognitive strategies to mitigate their memory loss. Although moderate gains in memory and cognitive abilities have been recorded with cognitive training, the general applicability of this approach has been significantly limited by two factors: 1) Lack of Generalization; and 2) Lack of enduring effect.

Lack of Generalization: Training benefits typically do not generalize beyond the trained skills to other types of cognitive tasks or to other “real-world” behavioral abilities. As a result, effecting significant changes in overall cognitive status would require exhaustive training of all relevant abilities, which is typically infeasible given time constraints on training.

Lack of Enduring Effect: Training benefits generally do not endure for significant periods of time following the end of training. As a result, cognitive training has appeared infeasible given the time available for training sessions, particularly from people who suffer only early cognitive impairments and may still be quite busy with daily activities.

As a result of overall moderate efficacy, lack of generalization, and lack of enduring effect, no cognitive training strategies are broadly applied to the problems of age-related cognitive decline, and to date they have had negligible commercial impacts. The applicants believe that a significantly innovative type of training can be developed that will surmount these challenges and lead to fundamental improvements in the treatment of age-related cognitive decline. This innovation is based on a deep understanding of the science of “brain plasticity” that has emerged from basic research in neuroscience over the past twenty years which only now through the application of computer technology can be brought out of the laboratory and into the everyday therapeutic treatment.

Therefore, what is needed is an overall training program that will significantly improve fundamental aspects of brain performance and function relevant to the remediation of the neurological origins and consequences of age-related cognitive decline. Additionally, improved means for helping listeners attend to the set of cues relevant to a synthetic speech distinction to reliably identify sounds and progress through exercises that utilize such distinctions.

### SUMMARY

Various embodiments of a system and method for increasing cognition and memory in a participant, e.g., an aging adult, are presented, utilizing a computing device to present aural stimuli, specifically, formant frequency sweeps, to the participant, and to record responses from the participant. Moreover, in some embodiments, a psychophysical threshold for the participant may be determined. The method may be performed in the context of a computer-based cognitive training exercise.

First, a first formant frequency sweep that increases in frequency over time, and a second formant frequency sweep that decreases in frequency over time, may be provided, where both the first and second formant frequency sweeps are available for aural presentation to the participant. In other words, upward and downward formant frequency sweeps may be provided, e.g., stored on the computing device, for audible presentation to the participant.

In some embodiments, each formant frequency sweep may be generated by synthesizing a pulse train, and processing the pulse train with a filter, e.g., a time-varying resonator, with the center or peak frequency determined by a rising or falling sweep pattern. In other words, the synthesized pulse train may be dynamically filtered to produce a rising or falling sweep pattern, where the center or peak (strongest component) frequency sweeps from (or to) a lowest frequency, specifically, a characteristic formant frequency, upward (or downward) through a specified range. These generated formant frequency sweeps may serve as a basis for stimuli presented during performance of the exercise described herein, as will be described below in detail.

Note that the generation of a formant frequency sweep differs from generating a tonal frequency sweep in that rather than simply modulating the frequency (tone) of a sinusoidal signal, a formant frequency sweep is generated by applying a dynamically changing single pole filter to a pulse train over time, where the filter is modulated to generate a changing resonance in the signal. The filter is tuned to sweep the peak frequency of the resulting signal to and/or from a characteristic formant frequency, i.e., a frequency that is representative of a spoken speech component, such as a consonant.

Note that the stimuli used in the exercise may be generated in accordance with various different characteristic formant frequencies, i.e., characteristic frequencies for various different common speech components. For example, in some embodiments, the stimuli (i.e., the formant frequency sweeps) may include base frequencies of approximately 500, 1000, and 2000 Hz, which may correspond to respective common formants (frequencies of characteristic qualities of common speech sounds), where each frequency is representative of a resonant band characterizing the formant. Base frequency refers to the low end of the pole location, in this case 500-2000 Hz, corresponding to the range of the lowest 2 or 3 formant frequencies of many common speech sounds.

In one embodiment, the formant frequency sweeps may be generated using an impulse train with periodicity 100 Hz (a nominal frequency for a male speaking voice), a constant base frequency of 1000 Hz, and a constant 16 octave per second sweep rate, although other values of these parameters may be used as desired. Moreover, these parameters are all easily manipulated and may be adjusted based on ongoing testing and assessment.

The upward and downward formant frequency sweeps may be associated with respective “up” and “down” icons. For example, the first formant frequency sweep that increases in frequency over time may be associated with a first icon, e.g., a button that displays an up arrow, and the second formant frequency sweep that decreases in frequency over time may be associated with a second icon, e.g., a button that displays a down arrow. In other words, the first icon may be a picture of an arrow pointing up and the second icon may be a picture of an arrow pointing down.

For example, in one embodiment, associating the first formant frequency sweep with the first icon may include aurally presenting the first formant frequency sweep, and then highlighting (i.e., graphically indicating) the first icon to indicate to the participant the association. Similarly, associating the second formant frequency sweep with the second icon may include aurally presenting the second formant frequency sweep, and then highlighting the second icon to indicate to the participant the association. Both the first and second formant frequency sweeps are then available for aural presentation to the participant.

In one embodiment, a “training” session may be provided to illustrate to the participant how the exercise is to be played. For example, an upward sweep may be presented to the participant, followed by an indication to the participant that they are to select the upward arrow block when they hear an upward sweep. Then, a downward sweep may be presented to the participant, followed by an indication to the participant that they are to select the downward arrow block when they hear a downward sweep. The initial training may continue by presenting the participant with an upward sweep, followed by a downward sweep, with corresponding indications as to the correct sequence of responses.

In one embodiment, the participant may be presented with several practice trials to insure that they understand how trials are to be responded to. Once the initial training completes, it is preferably not repeated. Rather, for example, after selecting a start button, an auditory sequence of formant frequency sweeps may be presented, and the participant must indicate the order of the formant frequency sweeps by selecting the appropriate blocks, according to the sequence, as described below.

At least two formant frequency sweeps may be aurally presented to the participant utilizing the first formant frequency sweep, the second formant frequency sweep, or a combination of the first and second formant frequency sweeps. In one embodiment, the aurally presenting may include randomly selecting at least two formant frequency sweeps to be presented, utilizing combinations of the first formant frequency sweep and the second formant frequency sweep. In one embodiment, the first formant frequency sweep may be referred to as UP, and the second formant frequency sweep may be referred to as DOWN, and the aurally presenting at least two formant frequency sweeps may include any of the following possible combinations: UP-UP, UP-DOWN, DOWN-UP, and DOWN-DOWN. Of course, other sequences of sweeps are also contemplated, and any such sequence may be used as desired, e.g., UP-DOWN-UP, DOWN-DOWN-UP-DOWN, and so forth. Note that the aural presentations may be made via any of a variety of means, such as, for example, via headphones attached to the computing device, speakers, and so forth.

Note that the formant frequency sweeps are presented (sequentially) with an inter-stimulus-interval (ISI), i.e., a specified time interval between successive formant frequency sweeps. In various embodiments, the term “duration” may refer to just the actual duration of each formant frequency sweep, the ISI, i.e., the time interval between successive formant frequency sweeps, or the actual sweep duration plus the ISI. In other words, in some embodiments, the sweep duration may be the presentation time of the stimulus, including the actual sweep duration and the ISI, or either of these components. Thus, in some embodiments, the stimulus duration may be a compound parameter or value.

The frequency ranges for the sweeps may be specified as desired, e.g., based on typical (aging) participant hearing frequency responses. For example, in some embodiments, the stimuli (i.e., the formant frequency sweeps) may include base frequencies of 500, 1000, and 2000 Hz, which may correspond to respective common formants (characteristic components of the quality of a speech sound), e.g., where each frequency is representative of a resonant band characterizing the formant. In some embodiments, the formant frequency sweep may be generated by filtering a synthetic pulse train with a fundamental frequency in the range of 150-200 Hz, although it should be noted that other values for the fundamental frequency may be used as desired, e.g., 100 Hz, etc. The filter results in a single pole in the spectrum of the sound, resembling a single “formant” resonant frequency of a human vocal tract. The center frequency of the formant (the pole location in the frequency domain) varies quickly over time, resembling what is commonly referred to as a formant transition or sweep in the speech signal caused by a quick change in the position of supra-laryngeal articulators, as in a consonant articulation. Base frequency refers to the low end of the pole location, e.g., in a range of 500-2000 Hz, corresponding to the range of the lowest 2 or 3 formant frequencies of many common speech sounds.

In some embodiments, if very brief stimuli (<=10 ms) are used, the fundamental frequency of the pulse train may be raised (e.g., from 100 Hz to ˜150-200 Hz, which is a nominal frequency for a high male or low female speaking voice), so that more than one impulse (and more than one frequency step) is included in the pulse train. It should be noted, however, that these particular values and relationships for the sweeps are meant to be exemplary only, and that other values may be used as desired.

The participant may then be required to respond to the at least two formant frequency sweeps by indicating, e.g., utilizing the icons, an order in which the at least two formant frequency sweeps were presented. In other words, the participant may, in response to hearing the sequence of formant frequency sweeps, indicate the perceived order of the sweeps via the two icons. For example, in the case of the two sweep sequence UP-DOWN, the participant should indicate the order by pressing the “up” icon, and then the “down” icon. For a three sweep sequence, e.g., DOWN-DOWN-UP, the participant should press the “down” icon twice, then the “up” icon, and so forth.

In one embodiment, the requiring may include receiving input from the participant selecting the icons in the order in which the at least two formant frequency sweeps were presented, including the participant placing a cursor over a icon and clicking a mouse, where each mouse click is recorded as a selection, recording the selections made by the participant, and recording whether the participant correctly identified the order in which the at least two formant frequency sweeps were presented.

Note that in other embodiments, other means of receiving input from the participant may be used. For example, the user may indicate the formant frequency sweep sequence order by pressing keys on a keyboard coupled to the computer, e.g., the “up” and “down” arrow keys, as mentioned above.

The duration of the formant frequency sweeps (i.e., the stimulus duration or presentation time) may then be modified, based on the participant's response. In one embodiment, modifying the duration based on the participant's response may include increasing the duration if the participant responds incorrectly, and decreasing the duration if the participant responds correctly. As noted above, in some embodiments, the stimulus duration may include the actual duration of the sweep, the ISI, or both the actual duration of the sweep and the ISI. Thus, modifying the duration may include modifying the ISI, the actual duration, or both. In embodiments where the duration includes both, in modifying the duration, the actual sweep duration and inter-stimulus-interval may be co-varied in the ratio of 1:1. In other words, the actual sweep duration and inter-stimulus-interval may have the same value, or in some embodiments, may maintain the same ratio when varied. Thus, the task may be made more difficult by changing both the duration of the formant frequency sweeps (shorter sweeps are more difficult) and decreasing the inter-stimulus interval (ISI) between the formant frequency sweeps (shorter ISIs are more difficult).

In one embodiment, the duration of the presented sweeps may be modified in accordance with a maximum likelihood procedure, such as a QUEST (quick estimation by sequential testing) threshold procedure, and/or a ZEST (zippy estimation by sequential testing) threshold procedure, described briefly below, although other threshold procedures may be used as desired.

In preferred embodiments, the above presenting, requiring, and modifying, may compose a trial in the exercise. Thus, for each trial, the duration of the sweep for that trial may be determined by the performance of the previous trial, or of a plurality of previous trials, as will be discussed below. In other words, the participant's response to the stimulus (formant frequency sweep), or to previous stimuli (e.g., correctly performing n trials consecutively), may determine the next sweep duration, e.g., via a maximum likelihood method. However, it should be noted that in some embodiments, other modification schemes may not be used. For example, in one embodiment, the duration (or possibly some other attribute of the formant sweep presentation) may be modified according to a pre-determined sequence or schedule of values, e.g., increasing the difficulty of the trials as the participant progresses through the exercise. Of course, in other embodiments, any other stimulus modification schemes or approaches may be used as desired.

The above aurally presenting, requiring, and modifying, may be repeated one or more times in an iterative manner to improve the participant's cognition, e.g., to improve the participant's ability to process auditory information, e.g., to process and understand human speech. In other words, the method may include performing a plurality of trials using formant frequency sweeps with a variety of stimulus durations to enhance the auditory processing capabilities of the participant. For example, in preferred embodiments, the repeating may be performed over a plurality of sessions, where the repeating occurs a specified number of times each day, for a number of days.

In some embodiments, performing the plurality of trials may include performing trials under each of a plurality of conditions, where each condition specifies the formant frequency sweeps and/or their presentation. In some embodiments, each condition may specify one or more of: base frequency of the formant frequency sweep, i.e., a lower bound on the sweep, the fundamental frequency of the formant frequency sweep (i.e., of the pulse train used to generate the sweep), the duration of the formant frequency sweep (possibly including the ISI), the ISI of the formant frequency sweep, the frequency range of the formant frequency sweep, the rate of the formant frequency sweep, and the number of formant frequency sweeps in the sequence of at least two formant frequency sweeps, among others.

Thus, for example, as noted above, formant frequency sweeps may be presented using various base frequencies, e.g., 500 Hz, 1000 Hz, and 2000 Hz, each corresponding to a formant frequency of a common speech component, such as a consonant. As another example, various durations of the formant frequency sweeps may be used, such as, for example, durations of 30 ms, 35 ms, 40 ms, 60 ms, and 80 ms, among others. As a further example, various values for the fundamental frequency of the formant frequency sweep (i.e., of the pulse train used to generate the sweep) may be used. For example, in some embodiments, a value of 100 Hz may be used for some sweeps, e.g., where the duration of the sweeps is above some threshold, e.g., >10 ms, but for sweeps below (or equal to) this (exemplary) threshold, i.e., for sweeps with durations <=10 ms, the fundamental frequency of the pulse train may be raised (e.g., from 100 Hz to ˜150-200 Hz). As noted above, this may allow more than one impulse (and more than one frequency step) to be included in the sweep. As a further example, various different sweep rates may be used, e.g., 8, 16, and 24 octaves per second.

In some embodiments, rather than just using specified values of attributes, attributes may be varied according to specified increments (or decrements), e.g., based on the participant's responses. For example, trials may begin with a specified ISI, e.g., equal to the sweep duration, then increment or decrement the ISI based on the participant's responses. The step sizes of these ISI increments/decrements may be specified in or by the conditions. For example, in one embodiment, the ISI step sizes may include 50 ms, 25 ms, 10 ms, and 5 ms, accessed via corresponding ISI step size indices 1-5. The method may use a specified scheme where a specified number of consecutive correct responses results in a decrement of the ISI, and a specified number of consecutive incorrect responses results in an increment of the ISI.

For example, in one exemplary progression scheme, when starting a series of trials performed with a specified duration value, the ISI step index is 1 (50 ms). This means that 3 consecutive correct trials may shorten the ISI by 50 ms and 1 incorrect may lengthen the ISI by 50 ms—a 3 up/1 down scheme. The step size index may be increased after every second sweeps reversal or change in direction of the sweep. Thus, three correct consecutive trials may shorten the ISI, while a single incorrect trial may lengthen the ISI. The change to a longer ISI after advancement to a shorter ISI is counted as one reversal. If the participant continues to respond incorrectly, decreasing the difficulty of trials (by increasing the ISI), these adjustments do not count as reversals. A “change in direction” due to 3 consecutive correct responses may count as a second reversal. A total of 8 reversals may be allowed within a duration, i.e., within a series of trials performed with a specified duration value; the 9^{th} reversal may result in the participant exiting the duration, i.e., exiting the series of trials with that duration value; the duration group (of trials) may remain open unless criteria for stable performance have been met. Note that the ISI never decreases to lower than 0 ms, and may also never be allowed to increase to more than some specified value, e.g., to more than 1000 ms. Thus, in some exemplary embodiments, the duration may be decreased if the participant correctly indicates the order in which the at least two formant frequency sweeps were presented a first specified number of times, i.e., for a first specified number of consecutive trials (e.g., 3), and the duration may be increased if the participant incorrectly indicates the order in which the at least two formant frequency sweeps were presented a second specified number of times, i.e., for a second specified number of consecutive trials (e.g., 1). It should be noted that the above ISI (and/or duration) modification or progression scheme is meant to be exemplary only, and that any scheme or schemes may be used as desired.

Note also that the above values for attributes of the formant frequency sweeps are meant to be exemplary only, and are not intended to limit the attributes to any particular values. Similarly, each of the conditions may specify any attributes desired.

Each condition may thus specify some combination of attributes of the formant frequency sweeps. Based on performance, the participant may progress through the exercise, performing trials under a series of conditions, where, over the course of the exercise, the conditions may make the trials more difficult. In some embodiments, the participant may progress through various levels or stages, e.g., where the lower levels or stages involve trials under easier conditions, and later levels or stages involve trials under more difficult conditions.

In some embodiments, the progression through the plurality of conditions may be specified, where, for example, the participant must finish level 1 before proceeding to level 2, and so forth. In other embodiments, the participant may perform trials under different sequences of conditions, where, for example, the participant may complete one sequence that progresses from easy to difficult trials, then perform trials under another sequence of conditions, also ranging from easy to difficult, and so forth. In other words, in some embodiments, progress through the various conditions may not be linear, but may involve “looping back”, repeating, and so forth, among the conditions. Said another way, the various conditions may form a complex grid of trial conditions, rather than a simple linear sequence of conditions, where trials may be performed in various sequences of conditions with particular variations of attributes. This non-linear variation of sweep attributes may facilitate a deeper and broader training experience for the participant.

In preferred embodiments, indications may be provided as to whether the participant correctly indicated the order of the formant frequency sweeps. For example, in one embodiment, if the participant correctly indicates the sweep order, i.e., they have correctly responded to the trial, the score indicator may increment, and a “ding” may be played to indicate a correct response. If the participant incorrectly indicates the sweep order, then they have incorrectly responded to the trial, and a “thunk” may be played to indicate an incorrect response. Of course, any other type of indication may be used as desired. Similarly, if the participant correctly performs a specified number of trials consecutively, an indication, e.g., graphical and/or audial, may be provided to the participant. Moreover, in some embodiments, bonus points may be awarded for such success.

Other features and advantages of the present invention will become apparent upon study of the remaining portions of the specification and drawings.

### BRIEF DESCRIPTION OF THE DRAWINGS

FIG. 1 is a block diagram of a computer system for executing a program according to some embodiments of the present invention;

FIG. 2 is a block diagram of a computer network for executing a program according to some embodiments of the present invention;

FIG. 3 is a chart illustrating frequency/energy characteristics of two phonemes within the English language;

FIG. 4 is a chart illustrating auditory reception of a phoneme by a subject having normal receptive characteristics, and by a subject whose receptive processing is impaired;

FIG. 5 is a chart illustrating stretching of a frequency envelope in time, according to one embodiment of the present invention;

FIG. 6 is a chart illustrating emphasis of selected frequency components, according to one embodiment of the present invention;

FIG. 7 is a chart illustrating up-down frequency sweeps of varying duration, separated by a selectable inter-stimulus-interval (ISI), according to one embodiment of the present invention;

FIG. 8 flowcharts a method for cognitive training using formant frequency sweeps, according to one embodiment;

FIG. 9 is a screen shot of an initial screen in the exercise High or Low, according to one embodiment;

FIG. 10 is a screen shot of a trial within the exercise High or Low, according to one embodiment;

FIG. 11 is a screen shot during a trial within the exercise High or Low showing progress within a graphical award portion of the screen; and

FIG. 12 is a screen shot showing a completed picture within a graphical award portion of the screen during training of the exercise High or Low.

### DETAILED DESCRIPTION

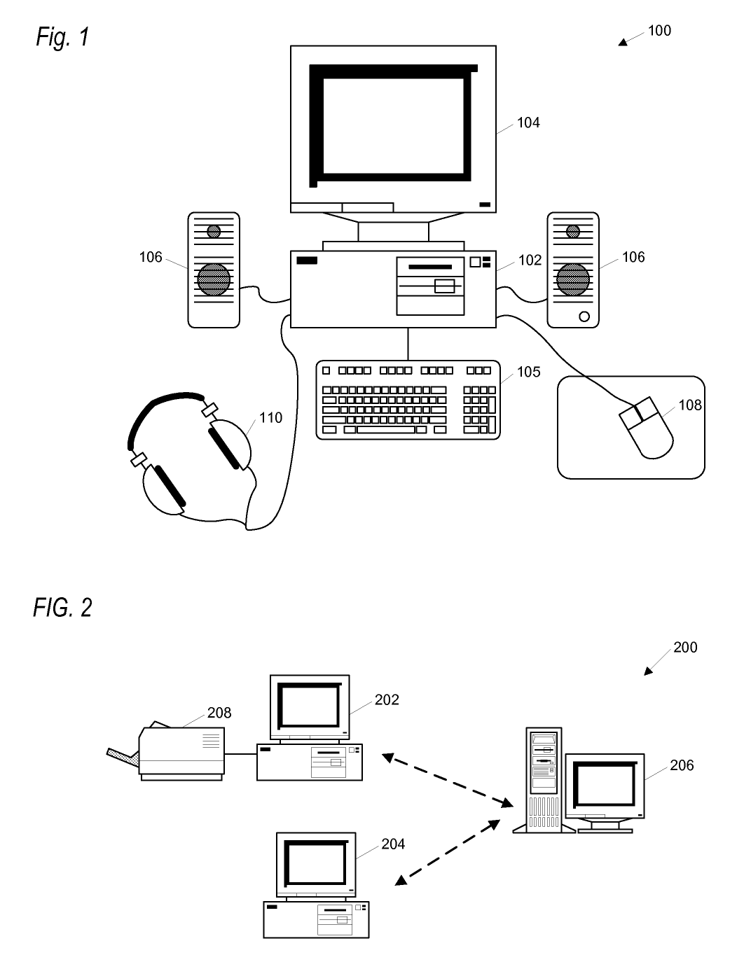

Referring to FIG. 1, a computer system 100 is shown for executing a computer program to train, or retrain an individual according to the present invention to enhance their memory and improve their cognition, where the term “cognition” refers to the speed, accuracy and reliability of processing of information, and attention and memory, and where the term “attention” refers to the facilitation of a target and/or suppression of a non-target over a given spatial extent, object-specific area or time window. The computer system 100 contains a computer 102, having a CPU, memory, hard disk and CD ROM drive (not shown), attached to a monitor 104. The monitor 104 provides visual prompting and feedback to the subject during execution of the computer program. Attached to the computer 102 are a keyboard 105, speakers 106, a mouse 108, and headphones 110. The speakers 106 and the headphones 110 provide auditory prompting and feedback to the subject during execution of the computer program. The mouse 108 allows the subject to navigate through the computer program, and to select particular responses after visual or auditory prompting by the computer program. The keyboard 105 allows an instructor to enter alpha numeric information about the subject into the computer 102. Although a number of different computer platforms are applicable to the present invention, embodiments of the present invention execute on either IBM compatible computers or Macintosh computers, or similarly configured computing devices such as set top boxes, PDA's, gaming consoles, etc.

Now referring to FIG. 2, a computer network 200 is shown. The computer network 200 contains computers 202, 204, similar to that described above with reference to FIG. 1, connected to a server 206. The connection between the computers 202, 204 and the server 206 can be made via a local area network (LAN), a wide area network (WAN), or via modem connections, directly or through the Internet. A printer 208 is shown connected to the computer 202 to illustrate that a subject can print out reports associated with the computer program of the present invention. The computer network 200 allows information such as test scores, game statistics, and other subject information to flow from a subject's computer 202, 204 to a server 206. An administrator can then review the information and can then download configuration and control information pertaining to a particular subject, back to the subject's computer 202, 204.

Before providing a detailed description of the present invention, a brief overview of certain components of speech will be provided, along with an explanation of how these components are processed by subjects. Following the overview, general information on speech processing will be provided so that the reader will better appreciate the novel aspects of the present invention.

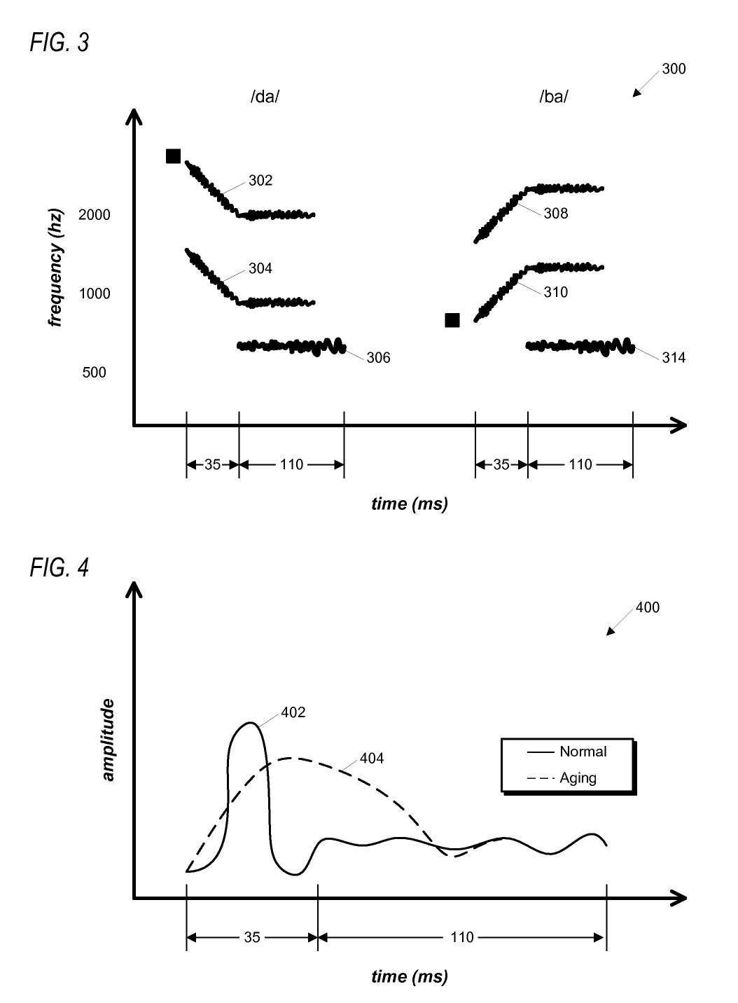

Referring to FIG. 3, a chart is shown that illustrates frequency components, over time, for two distinct phonemes within the English language. Although different phoneme combinations are applicable to illustrate features of the present invention, the phonemes /da/ and /ba/ are shown. For the phoneme /da/, a downward sweep frequency component 302 (called a formant), at approximately 2.5-2 kHz is shown to occur over a 35 ms interval. In addition, a downward sweep frequency component (formant) 304, at approximately 1 kHz is shown to occur during the same 35 ms interval. At the end of the 35 ms interval, a constant frequency component (formant) 306 is shown, whose duration is approximately 110 ms. Thus, in producing the phoneme /da/, the stop consonant portion of the element /d/ is generated, having high frequency sweeps of short duration, followed by a long vowel element /a/ of constant frequency.

Also shown are formants for a phoneme /ba/. This phoneme contains an upward sweep frequency component 308, at approximately 2 kHz, having a duration of approximately 35 ms. The phoneme also contains an upward sweep frequency component 310, at approximately 1 kHz, during the same 35 ms period. Following the stop consonant portion /b/ of the phoneme, is a constant frequency vowel portion 314 whose duration is approximately 110 ms.

Thus, both the /ba/ and /da/ phonemes begin with stop consonants having modulated frequency components of relatively short duration, followed by a constant frequency vowel component of longer duration. The distinction between the phonemes exists primarily in the 2 kHz sweeps during the initial 35 ms interval. Similarity exists between other stop consonants such as /ta/, /pa/, /ka/ and /ga/.

Referring now to FIG. 4, the amplitude of a phoneme, for example /ba/, is viewed in the time domain. A short duration high amplitude peak waveform 402 is created upon release of either the lips or the tongue when speaking the consonant portion of the phoneme, that rapidly declines to a constant amplitude signal of longer duration. For an individual with normal temporal processing, the waveform 402 will be understood and processed essentially as it is. However, for an individual whose auditory processing is impaired, or who has abnormal temporal processing, the short duration, higher frequency consonant burst will be integrated over time with the lower frequency vowel, and depending on the degree of impairment, will be heard as the waveform 404. The result is that the information contained in the higher frequency sweeps associated with consonant differences, will be muddled, or indistinguishable.

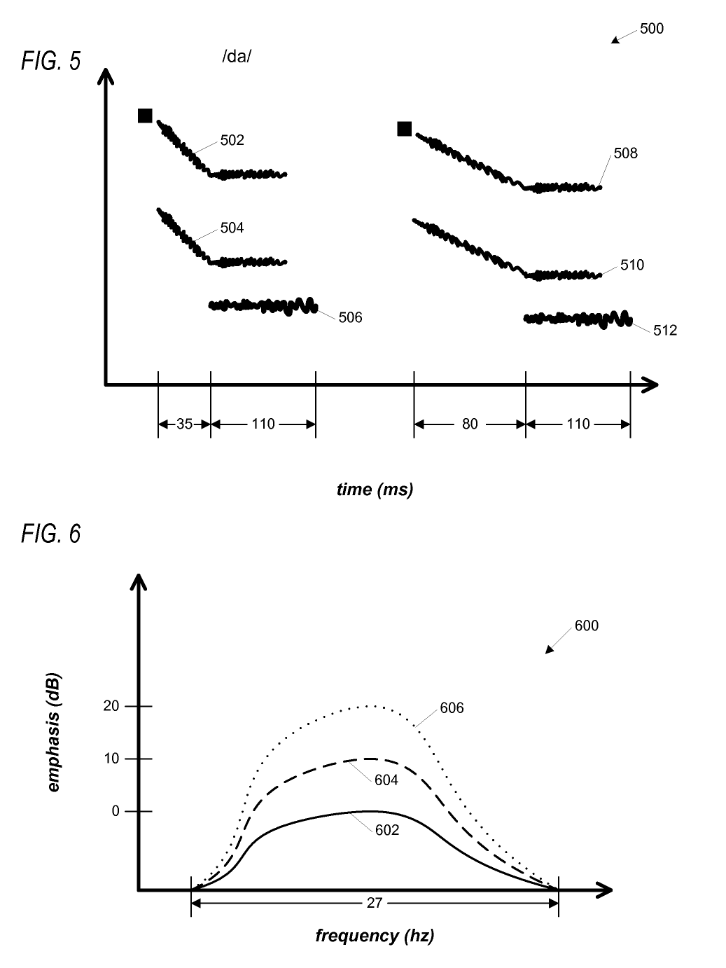

With the above general background of speech elements, and how subjects process them, a general overview of speech processing will now be provided. As mentioned above, one problem that exists in subjects is the inability to distinguish between short duration acoustic events. If the duration of these acoustic events are stretched, in the time domain, it is possible to train subjects to distinguish between these acoustic events. An example of such time domain stretching is shown in FIG. 5, to which attention is now directed.

In FIG. 5, a frequency vs. time graph 500 is shown similar to that described above with respect to FIG. 3. Using existing computer technology, the analog waveforms 502, 504 can be sampled and converted into digital values (using a Fast Fourier Transform, for example). The values can then be manipulated so as to stretch the waveforms in the time domain to a predetermined length, while preserving the amplitude and frequency components of the modified waveforms. The modified waveform can then be converted back into an analog waveform (using an inverse FFT) for reproduction by a computer, or by some other audio device. The waveforms 502, 504 are shown stretched in the time domain to durations of 80 ms (waveforms 508, 510). By stretching the consonant portion of the waveforms 502, 504 without affecting their frequency components, aging subjects with deteriorated acoustic processing can begin to hear distinctions in common phonemes.

Another method that may be used to help subjects distinguish between phonemes is to emphasize selected frequency envelopes within a phoneme. Referring to FIG. 6, a graph 600 is shown illustrating a filtering function 602 that is used to filter the amplitude spectrum of a speech sound. In one embodiment, the filtering function affects an envelope that is 27 Hz wide. By emphasizing frequency modulated envelopes over a range similar to frequency variations in the consonant portion of phonemes, they are made to more strongly engage the brain. A 10 dB emphasis of the filtering function 602 is shown in waveform 604, and a 20 dB emphasis in the waveform 606.

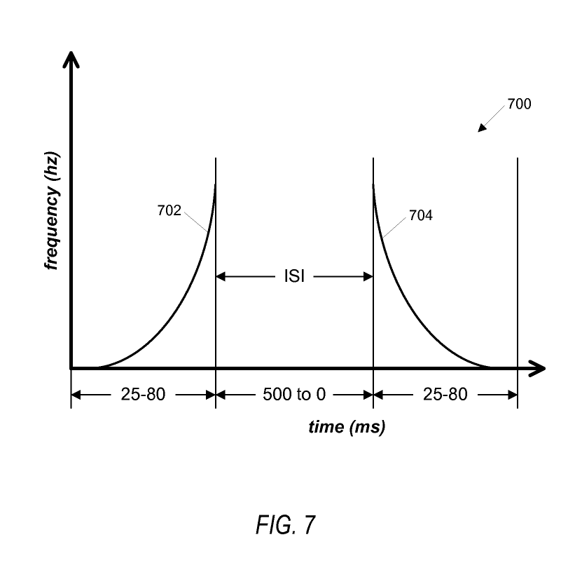

A third method that may be used to train subjects to distinguish short duration acoustic events is to provide frequency sweeps of varying duration, separated by a predetermined interval, as shown in FIG. 7. More specifically, an upward frequency sweep 702, and a downward frequency sweep 704 are shown, having duration's varying between 25 and 80 milliseconds, and separated by an inter-stimulus interval (ISI) of between 500 and 0 milliseconds. The duration and frequency of the sweeps, and the inter-stimulus interval between the sweeps are varied depending on the processing level of the subject, as will be further described below.

Such a method using tonal frequency sweeps was described in co-pending U.S. patent application Ser. No. 11/032,894, titled “A METHOD FOR ENHANCING MEMORY AND COGNITION IN AGING ADULTS”, filed Jan. 11, 2005, which was incorporated by reference above, and was referred to as “High or Low”. The embodiments of the exercise described below are novel variants of that exercise, where, instead of using tonal frequency sweeps, the exercise uses formant frequency sweeps, an overview of which is now presented. It should be noted that the name “High or Low” is meant to be descriptive, and is not intended to limit the invention or exercise described herein to any particular form, functionality, or appearance.

Formant Frequency Sweeps

A “formant” or “formant frequency” is a peak in the spectrum of a signal related to a resonant frequency of any acoustical system, although the term is used primarily with respect to speech acoustics. As is well known, in the generation of most speech sounds there is a “source” or carrier signal that is generated by the vibration of the glottis, and which forms or resembles a pulse train with a broad, relatively flat (but globally low-pass) frequency spectrum. The configuration of the upper vocal tract (for example, the positions of the tongue, lips, and jaw during vowel or consonant articulations) constantly imposes on this source signal (e.g., via filtering and resonance) a number of fairly defined peaks with frequencies that correspond to the characteristic frequencies of the acoustic system for a given configuration, referred to as formants. Typically these peak frequencies constantly change due to constantly changing vocal tract configurations. These changes are especially rapid in the neighborhood of consonant articulations, which involve very rapid articulator movements (for example, a quick downward movement of the tip of the tongue in the case of a “d” articulation).

The exercise described herein mimics this process in a very simplified way by creating or synthesizing a source signal, e.g., a pulse train (where the fundamental frequency of the pulse train may be (approximately) characteristic of a human speaker, e.g., ˜150-200 Hz), and applying a time-varying, single pole filter that may represent a single resonant frequency of a changing acoustic system, e.g., a human vocal apparatus. By varying the resonant frequency of the single-pole filter, e.g., from a specified base frequency (e.g., a characteristic formant frequency for a speech component) up to a specified upper frequency, the resulting signals may compose a formant frequency sweep. In other words, the formant frequency sweep may be generated by filtering a synthetic pulse train with a fundamental frequency in a specified range, e.g., 150-200 Hz (although other values may be used as desired, e.g., ˜100 Hz, etc.).

The pulse train preferably has a fundamental frequency that is characteristic of a human voice. The filtering results in a single pole in the spectrum of the sound, resembling a single “formant” resonant frequency of a human vocal tract. The center frequency of the formant (the pole location in the frequency domain) varies quickly over time, resembling or emulating what is commonly referred to as a formant transition or sweep in the speech signal caused by a quick change in the position of supra-laryngeal articulators, e.g., as in a consonant articulation, in human speech. In other words, the single pole filter has a time-varying resonant frequency including at least one formant frequency, and the formant frequency sweep includes a corresponding time-varying center frequency equal to the time-varying resonant frequency. The time-varying center frequency of the formant frequency sweep may have a lower bound equal to the at least one formant frequency, and the formant frequency sweep may emulate a formant transition in human speech.

Such formant frequency sweeps are utilized as stimuli in embodiments of the High or Low exercise described herein. It should be noted that these stimuli are different from the frequency modulated (FM) sweep stimuli of copending U.S. patent application Ser. No. 11/032,894, titled “A METHOD FOR ENHANCING MEMORY AND COGNITION IN AGING ADULTS”, filed Jan. 11, 2005, which was incorporated by reference above, in that the only commonality between them is that the peak frequency trajectories in the present stimuli match the sinusoid frequencies in the earlier stimuli, and that, as a result, they have similar spectra over time. In other words, the peak frequencies of the formant frequency sweeps described herein may change in the same way as the instantaneous frequency of the sinusoidal signals used in the earlier (tonal frequency sweep) version of the High or Low exercise (of application Ser. No. 11/032,894).

Cognitive Training Exercise with Formant Frequency Sweeps

The following describes embodiments of an exercise where formant frequency sweeps are presented to a participant, e.g., in a random order, and the participant is required to indicate the order of the sweeps.

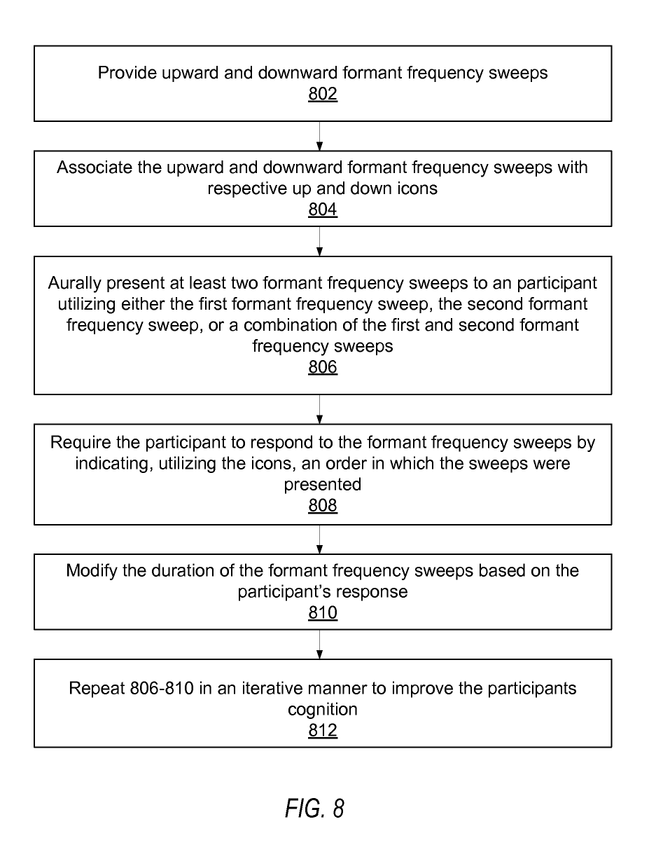

FIG. 8 is a high level flowchart of one embodiment of a method for improving cognition and memory in a participant, e.g., an aging adult, utilizing a computing device to present aural stimuli to the participant, and to record responses from the participant. Moreover, in some embodiments, the method includes determining a psychophysical threshold for the participant. Note that in various embodiments, some of the method elements may be performed concurrently, in a different order than shown, or may be omitted. Additional method elements may also be performed. As shown, the method may operate as follows:

In 802, a first formant frequency sweep that increases in frequency over time, and a second formant frequency sweep that decreases in frequency over time, may be provided, where both the first and second formant frequency sweeps are available for aural presentation to the participant. In other words, upward and downward formant frequency sweeps may be provided, e.g., stored on the computing device, for audible presentation to the participant.

In some embodiments, each formant frequency sweep may be generated by synthesizing a pulse train, and processing the pulse train with a filter, e.g., a time-varying resonator, with the center or peak frequency determined by a rising or falling sweep pattern. In other words, the synthesized pulse train may be dynamically filtered to produce a rising or falling sweep pattern, where the center or peak (strongest component) frequency sweeps from (or to) a lowest frequency, specifically, a characteristic formant frequency, upward (or downward) through a specified range. These generated formant frequency sweeps may serve as a basis for stimuli presented during performance of the exercise described herein, as will be described below in detail.

As noted above, the generation of a formant frequency sweep differs from generating a tonal frequency sweep in that rather than simply modulating the frequency (tone) of a sinusoidal signal, a formant frequency sweep is generated by applying a dynamically changing single pole filter to a pulse train over time, where the filter is modulated to generate a changing resonance in the signal. The filter is tuned to sweep the peak frequency of the resulting signal to and/or from a characteristic formant frequency, i.e., a frequency that is representative of a spoken speech component, such as a consonant.

Note that the stimuli used in the exercise may be generated in accordance with various different characteristic formant frequencies, i.e., characteristic frequencies for various different common speech components. For example, in some embodiments, the stimuli (i.e., the formant frequency sweeps) may include base frequencies of approximately 500, 1000, and 2000 Hz, which may correspond to respective common formants (frequencies of characteristic qualities of common speech sounds), where each frequency is representative of a resonant band characterizing the formant. Base frequency refers to the low end of the pole location, in this case 500-2000 Hz, corresponding to the range of the lowest 2 or 3 formant frequencies of many common speech sounds.

Note further that such formant frequency sweeps are generally more difficult to perceive and process than tonal frequency sweeps. For example, various tests have been performed in which a small number of participants attempted to identify 2-sweep sequences of both types (with sweep durations of 10-80 ms, and an inter-stimulus-interval (ISI) of 20 ms) in a single block. Results from these tests indicated that formant sweeps are slightly more difficult than tonal frequency sweeps, particularly at shorter sweep durations. In other words, detection thresholds (e.g., sweep durations corresponding to a specified performance level of the participants) are higher for formant sweeps than for tonal frequency sweeps.

In one embodiment, the formant frequency sweeps may be generated using an impulse train with periodicity 100 Hz (a nominal frequency for a male speaking voice), a constant base frequency of 1000 Hz, and a constant 16 octave per second sweep rate, although other values of these parameters may be used as desired. Moreover, these parameters are all easily manipulated and may be adjusted based on ongoing testing and assessment.

In 804, the upward and downward formant frequency sweeps may be associated with respective “up” and “down” icons. For example, the first formant frequency sweep that increases in frequency over time may be associated with a first icon, e.g., a button that displays an up arrow (see, e.g., FIG. 10, described below), and the second formant frequency sweep that decreases in frequency over time may be associated with a second icon, e.g., a button that displays a down arrow. In other words, the first icon may be a picture of an arrow pointing up and the second icon may be a picture of an arrow pointing down.

For example, in one embodiment, associating the first formant frequency sweep with the first icon may include aurally presenting the first formant frequency sweep, and then highlighting (i.e., graphically indicating) the first icon to indicate to the participant the association. Similarly, associating the second formant frequency sweep with the second icon may include aurally presenting the second formant frequency sweep, and then highlighting the second icon to indicate to the participant the association. Both the first and second formant frequency sweeps are then available for aural presentation to the participant.

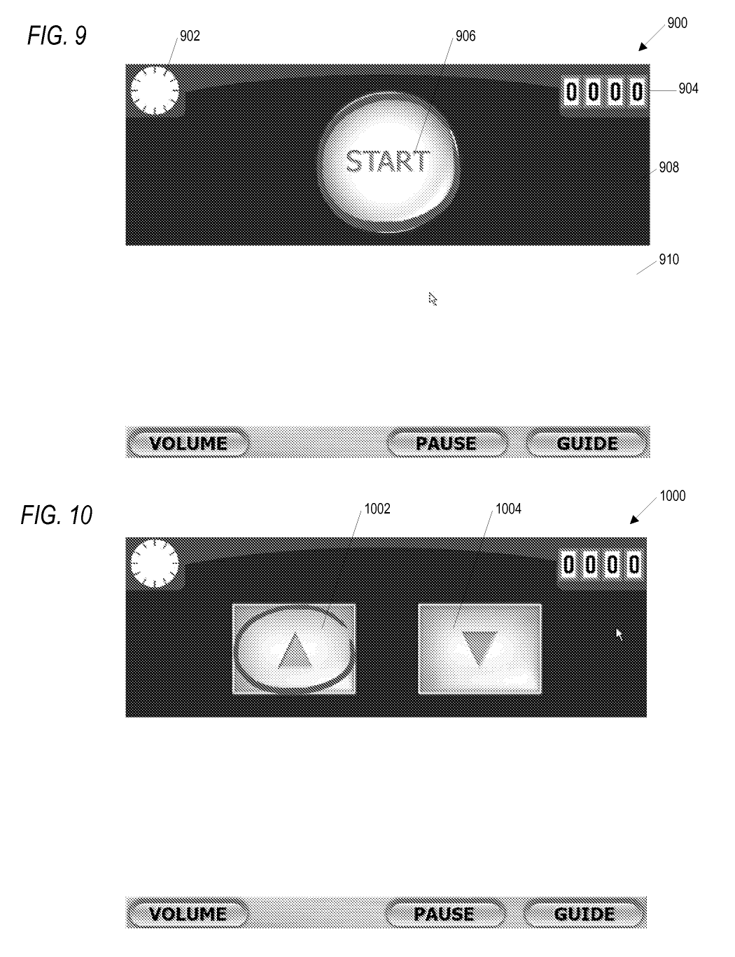

FIGS. 9 and 10 illustrate screenshots from an exemplary graphical user interface (GUI) for an embodiment of the exercise described herein. FIG. 9 illustrates an initial screen in the exercise, according to one embodiment. As may be seen, in the upper left of the screen 900 is a clock 902. Note that the clock 902 does not provide an absolute reference of time, but rather, provides a relative progress indicator according to the time prescribed for training in a particular game. For example, if the prescribed time for training were 12 minutes, each tick on the clock 902 would be 1 minute. Similarly, if the prescribed time for training were 20 minutes, then each tick on the clock would be 20/12 minutes.

Also shown in this embodiment is a score indicator 904 that increments according to correct responses by the participant. In one embodiment, the score does not increment linearly; rather, as described in co-pending application U.S. Ser. No. 10/894,388, filed Jul. 19, 2004 and entitled “REWARDS METHOD FOR IMPROVED NEUROLOGICAL TRAINING”, the score indicator 904 may increment non-linearly, with occasional surprise increments to create additional rewards for the participant. However, regardless of how the score is incremented, the score indicator provides the participant an indication of advancement in the exercise. As also shown, the screen 900 further includes a start button 906 (also referred to as the OR button). The purpose of the start button 906 is to allow the participant to select when they wish to begin a new trial. That is, when the participant places the cursor over the start button 906, the button may be highlighted. Then, when the participant indicates a selection of the start button 906 (e.g., by click the mouse), a new trial is begun. The screen 900 further includes a trial screen portion 908 and an optional graphical reward portion 910. The trial screen portion 908 provides an area on the participant's computer where trials are graphically presented. In some embodiments, the graphical reward portion 910 is provided, somewhat as a progress indicator, as well as a reward mechanism, to cause the participant to desire to advance in the exercise, as well as to entertain the participant. The format used within the graphical reward portion 910 is considered novel by the inventors, and will be further described below as well as shown. Note that in the embodiment shown, the screen of FIG. 9 also includes buttons or controls for adjusting volume (labeled “volume”), pausing the exercise (labeled “pause”), and for displaying instructions or helpful information (labeled “guide”).

Referring now to FIG. 10, an exemplary screen shot 1000 is shown of an initial trial within the exercise High or Low described herein. In one embodiment, the screen shot 1000 may be shown after the participant selects the start button 906. Elements of the screen 1000 described above with respect to FIG. 9 will not be referred to again, but it should be appreciated that unless otherwise indicated, their functions perform as described above with respect to FIG. 9. As shown, two icons or blocks 1002 and 1004 are presented to the participant. The left block 1002 shows an up arrow. The right block 1004 shows a down arrow. The blocks 1002, 1004 are intended to represent auditory formant frequency sweeps that sweep up or down in frequency, respectively. Within the context of this application, the blocks 1002, 1004 are referred to as icons. In one embodiment, icons are pictorial representations that are selectable by the participant to indicate a selection. Icons may graphically illustrate an association with an aural presentation, such as an up arrow 1002 representing an upward formant frequency sweep, or a down arrow 1004 representing a downward formant frequency sweep. Additionally, icons may be used to indicate correct selections to trials, or incorrect selections. Any use of a graphical item within the context of the present exercises, other than those described above with respect to FIG. 9 may be referred to as icons. In some instances, the term grapheme may also be used, although Applicant's believe that icon is more representative of selectable graphical items.

It should be noted that the above GUIs are meant to be exemplary only, and that other means for representing the formant frequency sweeps may be used as desired, e.g., other icons, arrow keys on a keyboard coupled to the computing system, etc.

In one embodiment, a “training” session may be provided to illustrate to the participant how the exercise is to be played. For example, an upward sweep may be presented to the participant, followed by an indication, as shown in FIG. 10, e.g., block 1002 circled in red, to indicate to the participant that they are to select the upward arrow block 1002 when they hear an upward sweep. Then, a downward sweep may be presented to the participant, followed by an indication (not shown) of block 1004 circled in red, to indicate to the participant that they are to select the downward arrow block 1004 when they hear a downward sweep. The initial training may continue by presenting the participant with an upward sweep, followed by a downward sweep, e.g., with red circles appearing first on block 1002, and then on block 1004, i.e., with corresponding indications as to the correct sequence of responses.

In one embodiment, the participant may be presented with several practice trials to insure that they understand how trials are to be responded to. Once the initial training completes, it is preferably not repeated. That is, the participant may no longer be presented with hints (e.g., see the red circles of FIGS. 9 and 10) to indicate the correct selection. Rather, as discussed above, after selecting the start button, an auditory sequence of formant frequency sweeps may be presented, and the participant must indicate the order of the formant frequency sweeps by selecting the appropriate blocks, according to the sequence.

In 806, at least two formant frequency sweeps may be aurally presented to the participant utilizing the first formant frequency sweep, the second formant frequency sweep, or a combination of the first and second formant frequency sweeps. In one embodiment, the aurally presenting may include randomly selecting at least two formant frequency sweeps to be presented, utilizing combinations of the first formant frequency sweep and the second formant frequency sweep. In one embodiment, the first formant frequency sweep may be referred to as UP, and the second formant frequency sweep may be referred to as DOWN, and the aurally presenting at least two formant frequency sweeps may include any of the following possible combinations: UP-UP, UP-DOWN, DOWN-UP, and DOWN-DOWN. Of course, other sequences of sweeps are also contemplated, and any such sequence may be used as desired, e.g., UP-DOWN-UP, DOWN-DOWN-UP-DOWN, and so forth. Note that the aural presentations may be made via any of a variety of means, such as, for example, via headphones attached to the computing device, speakers, and so forth.

Note that the formant frequency sweeps are presented (sequentially) with an inter-stimulus-interval (ISI), i.e., a specified time interval between successive formant frequency sweeps. In various embodiments, the term “duration” may refer to just the actual duration of each formant frequency sweep, the ISI, i.e., the time interval between successive formant frequency sweeps, or the actual sweep duration plus the ISI. In other words, in some embodiments, the sweep duration may be the presentation time of the stimulus, including the actual sweep duration and the ISI, or either of these components. Thus, in some embodiments, the stimulus duration may be a compound parameter or value.

The frequency ranges for the sweeps may be specified as desired, e.g., based on typical (aging) participant hearing frequency responses. For example, in some embodiments, the stimuli (i.e., the formant frequency sweeps) may include base frequencies of 500, 1000, and 2000 Hz, which may correspond to respective common formants (characteristic components of the quality of a speech sound), e.g., where each frequency is representative of a resonant band characterizing the formant. As described above, the formant frequency sweep may be generated by filtering a synthetic pulse train with a fundamental frequency in the range of 150-200 Hz, although it should be noted that other values for the fundamental frequency may be used as desired, e.g., 100 Hz, etc. The filter results in a single pole in the spectrum of the sound, resembling a single “formant” resonant frequency of a human vocal tract. The center frequency of the formant (the pole location in the frequency domain) varies quickly over time, resembling what is commonly referred to as a formant transition or sweep in the speech signal caused by a quick change in the position of supra-laryngeal articulators, as in a consonant articulation. Base frequency refers to the low end of the pole location, e.g., in a range of 500-2000 Hz, corresponding to the range of the lowest 2 or 3 formant frequencies of many common speech sounds.

In some embodiments, if very brief stimuli (<=10 ms) are used, the fundamental frequency of the pulse train may be raised (e.g., from 100 Hz to ˜150-200 Hz, which is a nominal frequency for a high male or low female speaking voice), so that more than one impulse (and more than one frequency step) is included in the pulse train. It should be noted, however, that these particular values and relationships for the sweeps are meant to be exemplary only, and that other values may be used as desired.

In 808, the participant may be required to respond to the at least two formant frequency sweeps by indicating, e.g., utilizing the icons, an order in which the at least two formant frequency sweeps were presented. In other words, the participant may, in response to hearing the sequence of formant frequency sweeps, indicate the perceived order of the sweeps via the two icons. For example, in the case of the two sweep sequence UP-DOWN, the participant should indicate the order by pressing the “up” icon, and then the “down” icon. For a three sweep sequence, e.g., DOWN-DOWN-UP, the participant should press the “down” icon twice, then the “up” icon, and so forth.

In one embodiment, the requiring may include receiving input from the participant selecting the icons in the order in which the at least two formant frequency sweeps were presented, including the participant placing a cursor over a icon and clicking a mouse, where each mouse click is recorded as a selection, recording the selections made by the participant, and recording whether the participant correctly identified the order in which the at least two formant frequency sweeps were presented.

Note that in other embodiments, other means of receiving input from the participant may be used. For example, the user may indicate the formant frequency sweep sequence order by pressing keys on a keyboard coupled to the computer, e.g., the “up” and “down” arrow keys, as mentioned above.

The duration of the formant frequency sweeps (i.e., the stimulus duration or presentation time) may then be modified, based on the participant's response, as indicated in 810. In one embodiment, modifying the duration based on the participant's response may include increasing the duration if the participant responds incorrectly, and decreasing the duration if the participant responds correctly. As noted above, in some embodiments, the stimulus duration may include the actual duration of the sweep, the ISI, or both the actual duration of the sweep and the ISI. Thus, modifying the duration may include modifying the ISI, the actual duration, or both. In embodiments where the duration includes both, in modifying the duration, the actual sweep duration and inter-stimulus-interval may be co-varied in the ratio of 1:1. In other words, the actual sweep duration and inter-stimulus-interval may have the same value, or in some embodiments, may maintain the same ratio when varied. Thus, the task may be made more difficult by changing both the duration of the formant frequency sweeps (shorter sweeps are more difficult) and decreasing the inter-stimulus interval (ISI) between the formant frequency sweeps (shorter ISIs are more difficult).

In one embodiment, the duration of the presented sweeps may be modified in accordance with a maximum likelihood procedure, such as a QUEST (quick estimation by sequential testing) threshold procedure, and/or a ZEST (zippy estimation by sequential testing) threshold procedure, described briefly below, although other threshold procedures may be used as desired.

In preferred embodiments, the above presenting (806), requiring (808), and modifying (810), may compose a trial in the exercise. Thus, for each trial, the duration of the sweep for that trial may be determined by the performance of the previous trial, or of a plurality of previous trials, as will be discussed below. In other words, the participant's response to the stimulus (formant frequency sweep), or to previous stimuli (e.g., correctly performing n trials consecutively), may determine the next sweep duration, e.g., via a maximum likelihood method. However, it should be noted that in some embodiments, other modification schemes may not be used. For example, in one embodiment, the duration (or possibly some other attribute of the formant sweep presentation) may be modified according to a pre-determined sequence or schedule of values, e.g., increasing the difficulty of the trials as the participant progresses through the exercise. Of course, in other embodiments, any other stimulus modification schemes or approaches may be used as desired.

In 812, the above presenting (806), requiring (808), and modifying (810), may be repeated one or more times in an iterative manner to improve the participant's cognition, e.g., to improve the participant's ability to process auditory information, e.g., to process and understand human speech. In other words, the method may include performing a plurality of trials using formant frequency sweeps with a variety of stimulus durations to enhance the participant's cognition, e.g., auditory processing capabilities. For example, in preferred embodiments, the repeating may be performed over a plurality of sessions, where the repeating occurs a specified number of times each day, for a number of days.

In some embodiments, performing the plurality of trials may include performing trials under each of a plurality of conditions, where each condition specifies the formant frequency sweeps and/or their presentation. In some embodiments, each condition may specify one or more of: base frequency of the formant frequency sweep, i.e., a lower bound on the sweep, the fundamental frequency of the formant frequency sweep (i.e., of the pulse train used to generate the sweep), the duration of the formant frequency sweep (possibly including the ISI), the ISI of the formant frequency sweep, the frequency range of the formant frequency sweep, the rate of the formant frequency sweep, and the number of formant frequency sweeps in the sequence of at least two formant frequency sweeps, among others.

Thus, for example, as noted above, formant frequency sweeps may be presented using various base frequencies, e.g., 500 Hz, 1000 Hz, and 2000 Hz, each corresponding to a formant frequency of a common speech component, such as a consonant. As another example, various durations of the formant frequency sweeps may be used, such as, for example, durations of 30 ms, 35 ms, 40 ms, 60 ms, and 80 ms, among others. As a further example, various values for the fundamental frequency of the formant frequency sweep (i.e., of the pulse train used to generate the sweep) may be used. For example, in some embodiments, a value of 100 Hz may be used for some sweeps, e.g., where the duration of the sweeps is above some threshold, e.g., >10 ms, but for sweeps below (or equal to) this (exemplary) threshold, i.e., for sweeps with durations <=10 ms, the fundamental frequency of the pulse train may be raised (e.g., from 100 Hz to ˜150-200 Hz). As noted above, this may allow more than one impulse (and more than one frequency step) to be included in the sweep. As a further example, various different sweep rates may be used, e.g., 8, 16, and 24 octaves per second.

In some embodiments, rather than just using specified values of attributes, attributes may be varied according to specified increments (or decrements), e.g., based on the participant's responses. For example, trials may begin with a specified ISI, e.g., equal to the sweep duration, then increment or decrement the ISI based on the participant's responses. The step sizes of these ISI increments/decrements may be specified in or by the conditions. For example, in one embodiment, the ISI step sizes may include 50 ms, 25 ms, 10 ms, and 5 ms, accessed via corresponding ISI step size indices 1-5. The method may use a specified scheme where a specified number of consecutive correct responses results in a decrement of the ISI, and a specified number of consecutive incorrect responses results in an increment of the ISI.

For example, in one exemplary progression scheme, when starting a series of trials performed with a specified duration value, the ISI step index is 1 (50 ms). This means that 3 consecutive correct trials may shorten the ISI by 50 ms and 1 incorrect may lengthen the ISI by 50 ms—a 3 up/1 down scheme. The step size index may be increased after every second sweeps reversal or change in direction of the sweep. Thus, three correct consecutive trials may shorten the ISI, while a single incorrect trial may lengthen the ISI. The change to a longer ISI after advancement to a shorter ISI is counted as one reversal. If the participant continues to respond incorrectly, decreasing the difficulty of trials (by increasing the ISI), these adjustments do not count as reversals. A “change in direction” due to 3 consecutive correct responses may count as a second reversal. A total of 8 reversals may be allowed within a duration, i.e., within a series of trials performed with a specified duration value; the 9^{th} reversal may result in the participant exiting the duration, i.e., exiting the series of trials with that duration value; the duration group (of trials) may remain open unless criteria for stable performance have been met. Note that the ISI never decreases to lower than 0 ms, and may also never be allowed to increase to more than some specified value, e.g., to more than 1000 ms. Thus, in some exemplary embodiments, the duration may be decreased if the participant correctly indicates the order in which the at least two formant frequency sweeps were presented a first specified number of times, i.e., for a first specified number of consecutive trials (e.g., 3), and the duration may be increased if the participant incorrectly indicates the order in which the at least two formant frequency sweeps were presented a second specified number of times, i.e., for a second specified number of consecutive trials (e.g., 1). It should be noted that the above ISI (and/or duration) modification or progression scheme is meant to be exemplary only, and that any scheme or schemes may be used as desired.

Note also that the above values for attributes of the formant frequency sweeps are meant to be exemplary only, and are not intended to limit the attributes to any particular values. Similarly, each of the conditions may specify any attributes desired.

Each condition may thus specify some combination of attributes of the formant frequency sweeps. Based on performance, the participant may progress through the exercise, performing trials under a series of conditions, where, over the course of the exercise, the conditions may make the trials more difficult. In some embodiments, the participant may progress through various levels or stages, e.g., where the lower levels or stages involve trials under easier conditions, and later levels or stages involve trials under more difficult conditions.

In some embodiments, the progression through the plurality of conditions may be specified, where, for example, the participant must finish level 1 before proceeding to level 2, and so forth. In other embodiments, the participant may perform trials under different sequences of conditions, where, for example, the participant may complete one sequence that progresses from easy to difficult trials, then perform trials under another sequence of conditions, also ranging from easy to difficult, and so forth. In other words, in some embodiments, progress through the various conditions may not be linear, but may involve “looping back”, repeating, and so forth, among the conditions. Said another way, the various conditions may form a complex grid of trial conditions, rather than a simple linear sequence of conditions, where trials may be performed in various sequences of conditions with particular variations of attributes. This non-linear variation of sweep attributes may facilitate a deeper and broader training experience for the participant.

In preferred embodiments, indications may be provided as to whether the participant correctly indicated the order of the formant frequency sweeps. For example, in one embodiment, if the participant correctly indicates the sweep order, i.e., they have correctly responded to the trial, the score indicator may increment, and a “ding” may be played to indicate a correct response. If the participant incorrectly indicates the sweep order, then they have incorrectly responded to the trial, and a “thunk” may be played to indicate an incorrect response. Of course, any other type of indication may be used as desired. Similarly, if the participant correctly performs a specified number of trials consecutively, an indication, e.g., graphical and/or audial, may be provided to the participant. Moreover, in some embodiments, bonus points may be awarded for such success.

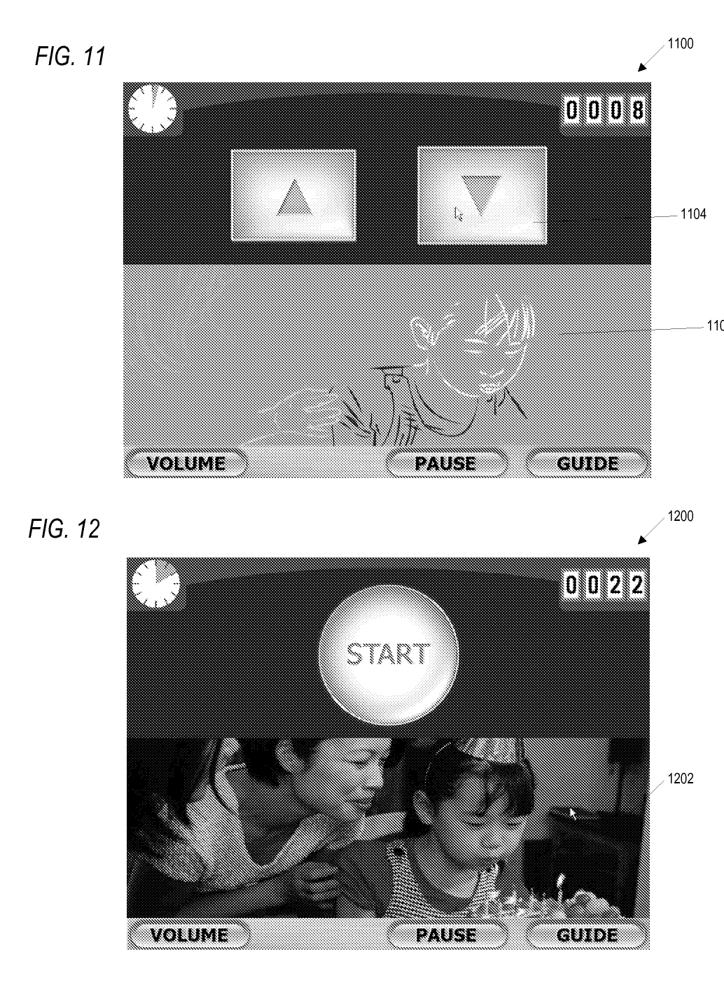

Referring now to FIG. 11, an exemplary screen shot 1100 is shown that illustrates an example trial in the High or Low exercise disclosed herein. In this instance, the right icon or block 1104 is being selected by the participant to indicate a downward formant frequency sweep, possibly as one of a sequence of formant frequency sweeps. If the participant correctly indicates the sweep order, the score indicator may be incremented, and a “ding” may be played, as above. In addition, in this embodiment, part of an image is shown traced out for the subject within the graphical reward portion 1106 of the screen 1100. That is, upon completion of a trial, a portion of a reward image may be traced as a graphical reward. After another trial, an additional portion of a reward image may be traced. Then, after several trials, the complete image may be completed and shown to the participant. Thus, in this embodiment, upon initiation of a first trial, the graphical reward portion 1106 is blank, but as each trial is completed, a respective portion of a reward image is presented, and after a number of trials, the image is completed. One skilled in the art will appreciate that the number of trials required to completely trace an image may vary. What is important is that in addition to incrementing a counter to illustrate correct responses, the participant is presented with a picture that progressively advances as they complete trials, whether or not the participant correctly responds to a trial, until they are rewarded with a complete image. It is believed that this progressive revealing of reward images both entertains and holds the interest of the participant. Additionally, it acts as an encouraging reward for completing a number of trials, even if the participant's score is not incrementing. Further, in one embodiment, the types of images presented to the participant are selected based on the demographics of the participant. For example, types of reward image libraries may include children, nature, travel, etc., and can be modified according to the demographics, or other interests of the subject being trained. No such graphical “reward” methodologies such as that shown and described with respect to the graphical reward portion are known in the prior art.

Referring to FIG. 12, a screen shot 1200 is shown directed to a trial within the High or Low exercise described herein. The screen shot 1200 includes a completed reward image 1202 in the graphical reward portion of the screen. In one embodiment, the reward image 1202 required the participant to complete six trials. However, one skilled in the art will appreciate that any number of trials might be selected before the reward image is completed. Once the reward image 1202 is completed, the next trial may begin with a blank graphical reward portion. Of course, these rewards are meant to be exemplary only, and that any other types of rewards may be used as desired.

It should be noted that the particular exercise disclosed herein is meant to be exemplary, and that other repetition-based cognitive training exercises using stimuli with multiple stimulus sets may be used as desired, possibly in combination. In other words, the formant frequency sweeps exercise described herein is but one example of a cognitive training exercise using a computing system to present stimuli to a participant, record the participant's responses, and modify some aspect of the stimuli based on these responses, where these method elements are repeated in an iterative manner using multiple sets of stimuli to improve cognition, e.g., to improve the ability of the participant to process information, e.g., auditory information. Note particularly that such cognitive training using a variety of such stimulus-based exercises, possibly in a coordinated manner, is contemplated.

Maximum Likelihood Procedures

As is well known, QUEST and ZEST procedures are adaptive psychometric procedures for use in psychophysical experiments, where stimuli are presented to a subject, and where an adaptive parameter or dimension variable of the stimuli is adjusted to a threshold value corresponding to some specified success rate.

The ZEST procedure is a maximum-likelihood strategy to estimate a subject's threshold in a psychophysical experiment based on a psychometric function that describes the probability a stimulus is detected as a function of the stimulus intensity. For example, consider a cumulative Gaussian psychometric function, F(x−T), for a 4-alternative-forced-choice (afc) task with a 5% lapsing rate, with proportion correct (ranging from 0-1) plotted against intensity of the stimulus (ranging from 0-5). As used herein, the term intensity (with respect to stimuli) refers to the value of the adaptive dimension variable being presented to the user at any particular trial in a particular exercise. For example, in the formant frequency sweep exercise described herein, the intensity value is the sweep duration (e.g., in log millisecond). In other words, the intensity value is that parameter regarding the exercise stimuli that may be adjusted or adapted, e.g., to make a trial more or less difficult. The threshold is defined to be the mean of the Gaussian distribution—e.g., a value yielding some specified success rate, e.g., a 60% success rate.

The primary idea of the ZEST procedure as applied to stimulus modification may be described as follows: given a prior probability density function (P.D.F.) centered around the best threshold guess, x, this P.D.F. is adjusted after each trial by one of two likelihood functions, which are the probability functions that the subject will respond “yes” or “no” to the stimulus at intensity as a function of threshold. Since the psychometric function has a constant shape and is of the form F(x−T), fixing the intensity x and treating threshold T as the independent variable, the “yes” likelihood, p=F(−(T−x)), is thus the mirror image of the psychometric function about the threshold, and the “no” likelihood function is then simply 1-p. The P.D.F. is updated using Bayes' rule, where the posterior P.D.F. is obtained by multiplying the prior P.D.F. by the likelihood function corresponding to the subject's response to the trial's stimulus intensity. The mean of the updated (or posterior) P.D.F. is then used as the new threshold estimate and the test is repeated with the new estimate until the posterior P.D.F. satisfies a confidence interval criteria (e.g. standard deviation of posterior P.D.F. <predetermined value) or a maximum number of trials is reached.

In one example of the ZEST procedure, a single trial of a 4-afc experiment is performed, with x=2.5 (intensity) as the initial threshold guess. If the subject responds correctly, the next trial is placed at the mean of the corresponding posterior P.D.F., ˜x=2.3; if the response is incorrect, the next trial is placed at the mean of the corresponding P.D.F., ˜x=2.65.

In some embodiments, e.g., for the periodic assessment mentioned above, a 2-stair ZEST procedure may be employed, where two independent tracks with starting values, preferably, encompassing the true threshold, each running its own ZEST procedure, are randomly interleaved in the threshold seeking procedure. In addition to their individual termination criterion, the difference between the two stairs may also be required to be within a specified range, e.g., the two stairs may be constrained to be a predetermined distance apart.

Thus, as mentioned above, in some embodiments, a maximum likelihood procedure, such as a ZEST or QUEST procedure, may be used as part of, or in conjunction with, the exercise described herein. For example, as noted above with reference to FIG. 8, the modifying of the duration described in method element 810 may be performed using such a procedure, e.g., a single-staircase ZEST procedure. The procedure may be used to modify or adjust an adaptive parameter, in this case, the sweep duration and/or ISI, to approach and/or maintain a value at which the participant performs at some specified level of success, e.g., 85% correct responses. Thus, as the participant improves, the duration and/or ISI may be modified accordingly, to maintain this level of success.

As another example, a maximum likelihood procedure, e.g., a double-staircase ZEST procedure, may be used to periodically assess the participant's progress in the exercise. For example, in one embodiment, assessment trials may be performed before training begins, and when the exercise is 25%, 50%, 75%, and 100% complete, thereby determining the participant's progress over the course of the exercise.

It should be noted that any of the techniques, parameters, and aspects disclosed above with respect to exercise and assessment methods described herein may be used with respect to any other exercises and assessment methods, as desired. In other words, any of the particular details described above with respect to any specific embodiment may be used with respect to any of the other embodiments disclosed herein as desired, the above descriptions being meant to be exemplary only, and not to restrict embodiments of the invention to any particular form, appearance, or function.

Moreover, although the present invention and its objects, features, and advantages have been described in detail, other embodiments are encompassed by the invention. For example, particular advancement/promotion methodology has been thoroughly illustrated and described for the exercise. The methodology for advancement through the exercise is based on studies indicating the need for frequency, intensity, motivation and cross-training. However, the number of skill/complexity levels provided for in the exercise, the number of trials for each level, and the percentage of correct responses required within the methodology are not static. Rather, they may change, based on heuristic information, as more participants utilize the “The Brain Fitness Program” training and assessment programs provided by Posit Science Corporation. Therefore, modifications to advancement/progression methodology are anticipated. In addition, one skilled in the art will appreciate that the stimuli described are merely a subset of stimuli that can be used within a training or assessment environment similar to HiFi.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims. For example, various embodiments of the methods disclosed herein may be implemented by program instructions stored on a memory medium, or a plurality of memory media.

We claim:

1. A method for improving cognition and memory in a participant, utilizing a computing device to present aural presentations to the participant, and to record responses from the participant, the method comprising the steps of:
providing a first formant frequency sweep which increases in frequency over time;
providing a second formant frequency sweep which decreases in frequency over time;
wherein both the first and second formant frequency sweeps are available for aural presentation to the participant;
associating the first formant frequency sweep with a first icon;
associating the second formant frequency sweep with a second icon;
aurally presenting a sequence of at least two formant frequency sweeps to the participant utilizing either the first formant frequency sweep, the second formant frequency sweep, or a combination of the first and second formant frequency sweeps;
requiring the participant to respond to the sequence of at least two formant frequency sweeps by indicating, utilizing the icons, an order in which the at least two formant frequency sweeps were presented;
modifying a duration of the formant frequency sweeps based on the participant's response;
repeating said steps of aurally presenting, requiring, and modifying, one or more times in an iterative manner to improve the participant's cognition.

2. The method of claim 1, wherein each formant frequency sweep is generated by:
synthesizing a pulse train; and
filtering the pulse train with a time-varying single pole filter to generate the formant frequency sweep.

3. The method of claim 2, wherein the single pole filter has a time-varying resonant frequency comprising at least one formant frequency, and wherein the formant frequency sweep comprises a corresponding time-varying center frequency equal to the time-varying resonant frequency.

4. The method of claim 3, wherein the time-varying center frequency of the formant frequency sweep has a lower bound equal to the at least one formant frequency.

5. The method of claim 2, wherein the pulse train has a fundamental frequency that is characteristic of a human voice.

6. The method of claim 1, wherein the formant frequency sweep emulates a formant transition in human speech.

7. The method of claim 1,
wherein the first formant frequency sweep is referred to as UP, and the second formant frequency sweep is referred to as DOWN; and
wherein said step of aurally presenting the sequence of at least two formant frequency sweeps comprises one of the following possible combinations:
UP-UP, UP-DOWN, DOWN-UP, and DOWN-DOWN.

8. The method of claim 1, wherein the first icon is a picture of an arrow pointing up and the second icon is a picture of an arrow pointing down.

9. The method of claim 1, wherein said associating the first formant frequency sweep with a first icon comprises:
aurally presenting the first formant frequency sweep; and
after said step of aurally presenting the first formant frequency sweep, highlighting the first icon to indicate to the participant the association.

10. The method of claim 1, wherein said associating the second formant frequency sweep with a second icon comprises:
aurally presenting the second formant frequency sweep; and
after said step of aurally presenting the second formant frequency sweep, highlighting the second icon to indicate to the participant the association.

11. The method of claim 1, wherein said step of requiring comprises:
receiving input from the participant selecting the icons in the order in which the at least two formant frequency sweeps were presented, comprising the participant placing a cursor over a icon and clicking a mouse, wherein each mouse click is recorded as a selection;
recording the selections made by the participant; and
recording whether the participant correctly identified the order in which the at least two formant frequency sweeps were presented.

12. The method of claim 1, wherein said step of aurally presenting comprises:
randomly selecting at least two formant frequency sweeps to be presented, utilizing combinations of the first formant frequency sweep and the second formant frequency sweep.

13. The method of claim 1, wherein the aural presentations are made via headphones attached to the computing device.

14. The method of claim 1, wherein the aural presentations are made via speakers attached to the computing device.

15. The method of claim 1, further comprising:
performing a plurality of practice trials to demonstrate what is expected of the participant.

16. The method of claim 1, wherein said modifying the duration of the formant frequency sweeps based on the participant's response comprises:
modifying the duration in accordance with a maximum likelihood procedure.

17. The method of claim 16, wherein the maximum likelihood procedure comprises one or more of:
a QUEST (quick estimation by sequential testing) threshold procedure; or
a ZEST (zippy estimation by sequential testing) threshold procedure.

18. The method of claim 1, wherein the duration comprises:
an actual duration of the formant frequency sweep;
an inter-stimulus-interval (ISI), comprising a time interval between successive formant frequency sweeps; or
the actual duration plus the ISI.

19. The method of claim 18, wherein said modifying the duration of the formant frequency sweeps based on the participant's response comprises:
increasing the duration if the participant incorrectly indicates the order in which the at least two formant frequency sweeps were presented; and
decreasing the duration if the participant correctly indicates the order in which the at least two formant frequency sweeps were presented.

20. The method of claim 18, wherein said modifying the duration of the formant frequency sweeps based on the participant's response comprises:
decreasing the duration if the participant correctly indicates the order in which the at least two formant frequency sweeps were presented a first specified number of times; and
increasing the duration if the participant incorrectly indicates the order in which the at least two formant frequency sweeps were presented a second specified number of times.

21. The method of claim 1, wherein the duration comprises:
a presentation time of the formant frequency sweep, including the ISI.

22. The method of claim 1, further comprising:
assessing the participant's progress in the exercise two or more times.

23. The method of claim 1, wherein said assessing the participant's progress is performed using a maximum likelihood procedure.

24. The method of claim 1, wherein maximum likelihood procedure comprises one or more of:
a QUEST (quick estimation by sequential testing) threshold procedure; or
a ZEST (zippy estimation by sequential testing) threshold procedure.

25. The method of claim 1, wherein said steps of aurally presenting, requiring, and modifying compose performing a trial, wherein said repeating comprises:
performing a plurality of trials under each of a plurality of conditions, and wherein each condition specifies one or more attributes of the formant frequency sweep and/or its presentation.

26. The method of claim 25, wherein each of the plurality of conditions specifies one or more of:
base frequency of the formant frequency sweep, comprising a lower bound on the sweep;
fundamental frequency of the formant frequency sweep;
duration of the formant frequency sweep;
frequency range of the formant frequency sweep;
rate of the formant frequency sweep;
ISI of the formant frequency sweep; and
number of formant frequency sweeps in the sequence of at least two formant frequency sweeps.

27. The method of claim 25, further comprising:
after each trial, providing a graphical reward to the participant regardless of whether the participant indicated the order of the at least two formant frequency sweeps correctly or incorrectly.

28. The method of claim 1, further comprising:
indicating whether the participant indicated the order of the at least two formant frequency sweeps correctly, wherein said indicating is performed audibly and/or graphically.

29. The method of claim 1, wherein said repeating occurs a specified number of times each day, for a number of days.

30. A computer readable memory medium that stores program instructions for improving cognition and memory in a participant, utilizing a computing device to present aural presentations to the participant, and to record responses from the participant, wherein the program instructions are executable to perform:
providing a first formant frequency sweep which increases in frequency over time;
providing a second formant frequency sweep which decreases in frequency over time;
wherein both the first and second formant frequency sweeps are available for aural presentation to the participant;
associating the first formant frequency sweep with a first icon;
associating the second formant frequency sweep with a second icon;
aurally presenting a sequence of at least two formant frequency sweeps to the participant utilizing either the first formant frequency sweep, the second formant frequency sweep, or a combination of the first and second formant frequency sweeps;
requiring the participant to respond to the sequence of at least two formant frequency sweeps by indicating, utilizing the icons, an order in which the at least two formant frequency sweeps were presented;
modifying the duration of the formant frequency sweeps based on the participant's response;
repeating said steps of aurally presenting, requiring, and modifying, one or more times in an iterative manner to improve the participant's cognition.
